(19) United States
(12) Patent Application Publication
(10) Pub. No.: US 2018/0367913 A1
(43) Pub. Date: Dec. 20, 2018

(54) Vibration Diaphragm

(71) Applicant: AAC Technologies Pte. Ltd., Singapore City (SG)

(72) Inventors: Meiwei Wu, Shenzhen (CN); Xiaojiang Gu, Shenzhen (CN)

(21) Appl. No.: 15/828,866

(22) Filed: Dec. 1, 2017

(30) Foreign Application Priority Data
Jun. 20, 2017 (CN) 201720723639.1

(51) Int. Cl. H04R 7/18; H04R 7/12; G10K 13/00

(52) U.S. Cl. CPC H04R 7/18; G10K 13/00; H04R 7/127

(57) ABSTRACT

The present disclosure provides a vibration diaphragm. The vibration diaphragm includes a central dome part; and a suspension part surrounding the dome part. The suspension part includes a protruding part and a fixation part extending outwards from the protruding part. The protruding part includes two opposite long-axis sides, two short-axis sides and corner parts connecting adjacent long-axis sides and short-axis sides. The vibration diaphragm further includes a number of first reinforcing parts located on the long-axis sides and extending along the long-axis sides.

### FIELD OF THE PRESENT DISCLOSURE

The present disclosure relates to electro-acoustic transducers, more particularly to a vibration diaphragm for radiating audible sounds.

### DESCRIPTION OF RELATED ART

With the rapid development of portable devices like mobile phone etc, people's requirement to the performance of the product is becoming stronger and stronger, and there is a vibration mode of music belt for the music appreciation of the mobile phone, in order to strengthen the entertaining effect, thus, the development of the sounding instrument is accelerating accordingly.

The sounding instrument with relevant technology comprises a frame, a vibration diaphragm supported on the frame and a voice coil driving the vibration of the vibration diaphragm. The vibration diaphragm comprises a dome and a suspension extending along the dome, and the voice coil is fixed on the suspension.

However, in the vibration diaphragm with relevant technologies, the dome is a simple plane structure, and this structure makes the acoustic performance of the vibration diaphragm not improved further, and affects badly the acoustic performance of the vibration diaphragm.

Therefore it is necessary to provide an improved vibration diaphragm for overcoming the above-mentioned disadvantages.

### BRIEF DESCRIPTION OF THE DRAWINGS

Many aspects of the exemplary embodiment can be better understood with reference to the following drawing. The components in the drawing are not necessarily drawn to scale, the emphasis instead being placed upon clearly illustrating the principles of the present disclosure.

FIG. 1 is an illustrative isometric view of a vibration diaphragm in accordance with an exemplary embodiment of the present disclosure.

FIG. 2 is a top view of the vibration diaphragm in FIG. 1.

FIG. 3 is an enlarged view of Part A of the vibration diaphragm in FIG. 1.

FIG. 4 is an enlarged view of Part B of the vibration diaphragm in FIG. 1.

### DETAILED DESCRIPTION OF THE EXEMPLARY EMBODIMENT

The present disclosure will hereinafter be described in detail with reference to an exemplary embodiments. To make the technical problems to be solved, technical solutions and beneficial effects of the present disclosure more apparent, the present disclosure is described in further detail together with the figure and the embodiment. It should be understood the specific embodiment described hereby is only to explain the disclosure, not intended to limit the disclosure.

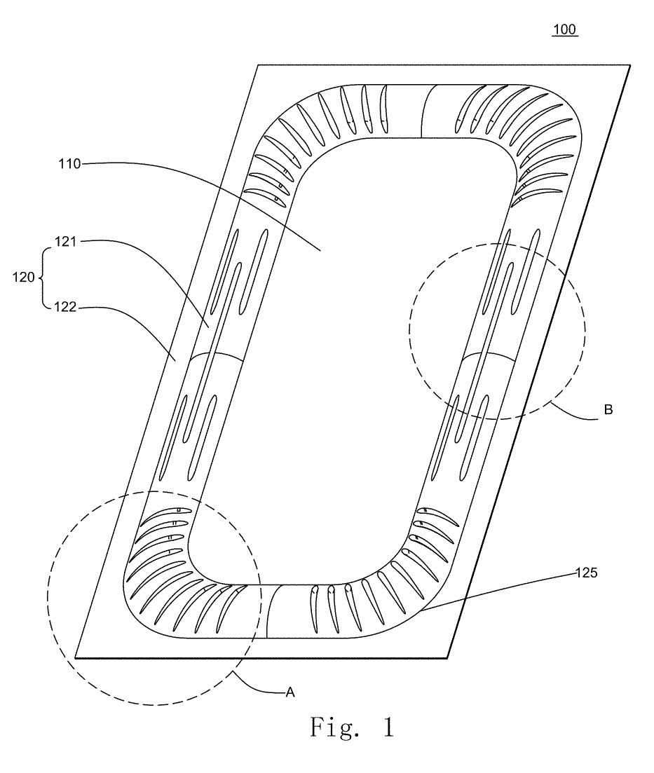

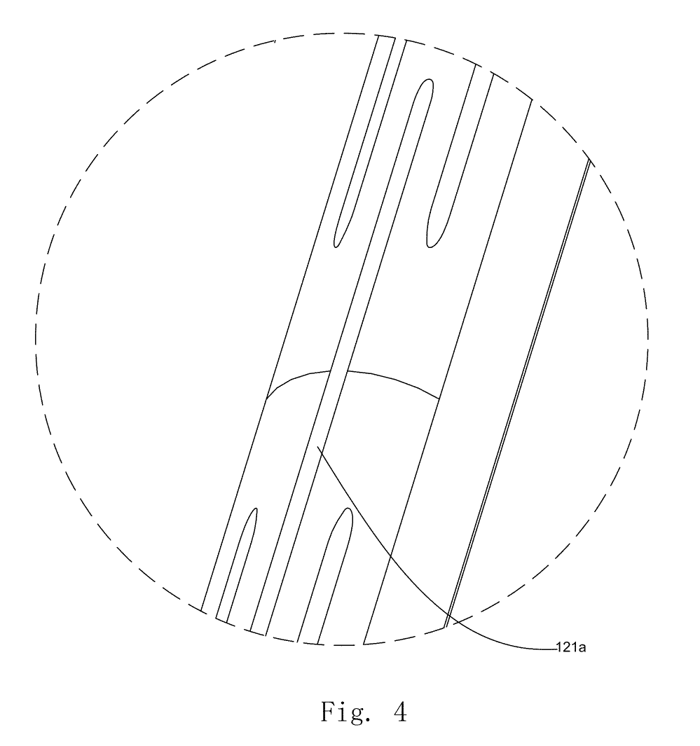

As shown in FIGS. 1-4, a vibration diaphragm 100 in accordance with an exemplary embodiment of the present disclosure is herein disclosed. The vibration diaphragm 100 is mainly applied in the sounding device of electronic equipment. The sounding device typically comprises a magnetic circuit system and a vibration system, wherein the magnetic circuit system comprises a yoke and a magnet steel accommodated in the yoke, and there is a magnetic gap between the yoke and the magnet; and the vibration system comprises a voice coil suspended in the magnetic gap and the vibration diaphragm 100 which is connected with the voice coil and driven by the same to vibrate.

The vibration diaphragm 100 comprises a central dome part 110 and a suspension part 120 encircling the dome part 110, wherein the suspension part 120 has an annular, protruding part 121 and a fixation part 122 extending outwards from the annular, protruding part 121. That is to say, the annular, protruding part 121 covers the central dome part 110.

The annular, protruding part 121 comprises two opposite long-axis sides 123, two short-axis sides 124 and corner parts 125 connecting adjacent long-axis sides 123 and short-axis sides 124. First reinforcing parts 121a are provided on the long-axis sides 123 and extend along the long-axis sides 123.

In the vibration diaphragm 100 of the structure according to this embodiment, first reinforcing parts 121a are provided on the long-axis side 123 of the annular, protruding part 121 and extend along the long-axis sides 123, which can effectively improve the strength of the vibration diaphragm 100. Especially when the annular, protruding part 121 has a very long long-axis side 123, the strength is significantly improved, the vibration diaphragm collapsing is reduced, the life of the vibration diaphragm is prolonged and the sounding device with the vibration diaphragm 100 has an excellent sound generating performance.

It should be noted that no limitation is made to the structures of the first reinforcing parts 121a, for example, their protruding direction may be the same as or opposite to that of the annular, protruding part 121; no limitation is made herein.

As shown in FIG. 1, the first reinforcing part 121a may be a long strip, the number of first reinforcing parts 121a may be more than one, and the multiple first reinforcing parts 121a may be provided spaced apart.

That is to say, for the vibration diaphragm 100 of the structure, multiple first reinforcing parts 121a are arranged side by side on the long-axis sides 123, which allows the strength of the vibration diaphragm 100 to be further significantly improved. Especially when the annular, protruding part 121 of the vibration diaphragm 100 has a very long long-axis side 123, the vibration diaphragm collapsing can be effectively reduced; besides, the vibration diaphragm 100 of the structure can be also easily fabricated and requires less cost.

It should be noted that the multiple first reinforcing part 121a may extend for the same length or different lengths along the long-axis sides 123. Besides, the distance between two adjacent first reinforcing parts 121a may be the same or different.

Specifically, the protruding direction of the first reinforcing parts 121a is the same as that of the annular, protruding part 121. Of course, the protruding direction of the first reinforcing parts 121a may also be different from that of the annular, protruding part 121, or when multiple first reinforcing parts 121a are provided, the protruding direction of some of the first reinforcing parts 121a is the same as that of the annular, protruding part 121, and the protruding direction of the rest of the first reinforcing parts 121a is opposite to that of the annular, protruding part 121, etc.

In the vibration diaphragms 100 of both structures described above, the strength of the vibration diaphragm at the long-axis sides 123 of the annular, protruding part 121 can be effectively improved, and the vibration diaphragm collapsing is reduced. Taking the convenience of fabricating processes into consideration, the first reinforcing parts 121a of the second structure are preferable, i.e. the protruding direction of the first reinforcing parts 121a is opposite to that of the annular, protruding part 121.

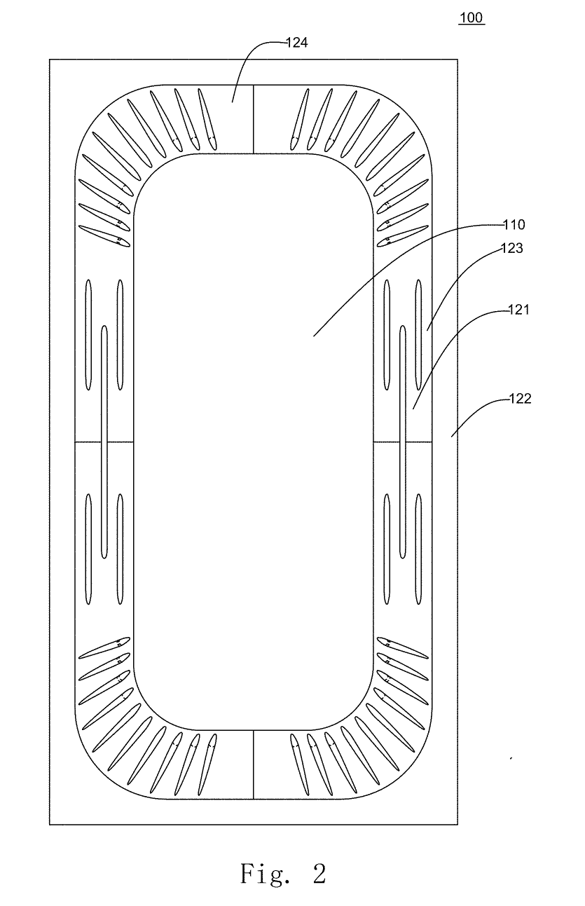

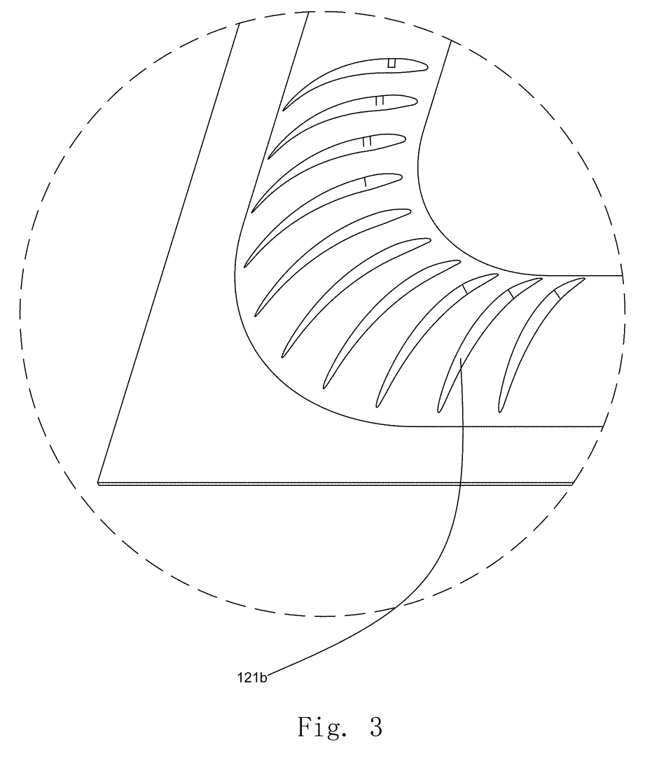

As shown in FIG. 2 and FIG. 3, second reinforcing parts 121b are provided across the corner parts 125 on the corner parts 125. Specifically, as shown in FIG. 3, the second reinforcing parts 121b decrease progressively in turn in width from the inside of the corner parts 125 to the outside of the corner parts 125. Of course, the second reinforcing parts 121b may also decrease progressively in turn in width from the outside of the corner parts 125 to the inside of the corner parts 125.

In the vibration diaphragm 100 of the structure according to the embodiment, the provision of the second reinforcing parts 121b at the corner parts 125 of the annular, protruding part 121 as across the corner parts 125 can effectively improve the strength of the vibration diaphragm 100 at the corner part 125 and reduce the vibration diaphragm collapsing.

In order to further improve the strength of the vibration diaphragm, the corner parts 125 of the annular, protruding part 121 are rounded off.

A sounding device is provided according to the second aspect of the present utility model (not shown in figures). The sounding device comprises a magnetic circuit system (not shown in figures), a vibration system (not shown in figures) and a frame accommodating the magnetic circuit system and the vibration system (not shown in figures), wherein the vibration system includes the vibration diaphragm 100 described above.

The sounding device of the structure according to the embodiment includes the vibration diaphragm 100 described above. The vibration diaphragm 100 of such a structure has improved strength and does not collapse easily, so the life of the sounding device is prolonged and its sound generating effect is improved.

An electronic equipment (not shown in figures) is provided according to the third aspect of the present utility model, and the electronic equipment comprises the sounding device described above.

The electronic equipment of the structure according to the embodiment has the sounding device described above which has the vibration diaphragm 100 described above, the sound generating effect of the electronic equipment is effectively improved and the life of the product is prolonged.

It should be noted that the electronic equipment may comprise electronic products such as cell phones, tablets.

It is to be understood, however, that even though numerous characteristics and advantages of the present exemplary embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A vibration diaphragm comprising:
a central dome part;
a suspension part surrounding the dome part, the suspension part including a protruding part and a fixation part extending outwards from the protruding part; wherein
the protruding part includes two opposite long-axis sides, two short-axis sides and corner parts connecting adjacent long-axis sides and short-axis sides, and the vibration diaphragm further includes a plurality of first reinforcing parts located on the long-axis sides and extending along the long-axis sides.

2. The vibration diaphragm as described in claim 1, wherein the first reinforcing part is a long strip.

3. The vibration diaphragm as described in claim 2 including at least two first reinforcing parts spaced apart from each other.

4. The vibration diaphragm as described in claim 1, wherein a protruding direction of the first reinforcing part is same to that of the protruding part.

5. The vibration diaphragm as described in claim 1, wherein a protruding direction of the first reinforcing part is different from that of the protruding part.

6. The vibration diaphragm as described in claim 1 further including a plurality of second reinforcing parts located on and across the corner parts of the protruding part of the suspension part.

7. The vibration diaphragm as described in claim 6, wherein the second reinforcing parts decrease progressively in turn in width from inside of the corner parts to outside of the corner parts, or decrease progressively in turn in width from the outside of the corner parts to the inside of the corner parts.

8. The vibration diaphragm as described in claim 1, wherein the corner parts of the protruding part are rounded off.
